(19) United States
(12) Patent Application Publication
(10) Pub. No.: US 2026/0286905 A1
(43) Pub. Date: Sep. 24, 2026

(54) METHOD FOR SUPPLYING FUEL TO AT LEAST ONE GAS TURBINE COMBUSTION CHAMBER AND ASSOCIATED FUEL SUPPLY SYSTEM

(71) Applicant: GE Vernova Infrastructure Technology LLC, Greenville, SC (US)

(72) Inventors: Pierre MONTAGNE, BELFORT (FR); Ezio PENA SAAVEDRA, BELFORT (FR); Eric IMPELLIZZERI, BELFORT (FR); Sébastien CAGNE, BELFORT (FR); Sylvain DELIMOGES, BELFORT (FR); Alexandre CHAILAN, BELFORT (FR); Maxime BUQUET, BELFORT (FR); Thomas R. FARRELL, GREENVILLE, SC (US); Michael John HUGHES, GREENVILLE, SC (US)

(21) Appl. No.: 19/140,812

(22) PCT Filed: Dec. 21, 2023
(86) PCT No.: PCT/EP2023/087487

§ 371 Date: Jun. 18, 2025

(30) Foreign Application Priority Data
Dec. 23, 2022 (FR) FR2214356

(51) Int. Cl. F02C 9/40; F02C 3/22; F02C 7/232

(52) U.S. Cl. CPC F02C 9/40; F02C 3/22; F02C 7/232; F05D 2260/606; F05D 2260/85

(57) ABSTRACT

A method for supplying fuel to at least one gas turbine combustion chamber of a gas turbine includes: directing a blend of hydrocarbon and hydrogen into a supply line connected to at least one combustion chamber; separating the blend of hydrocarbon and hydrogen in a bypass circuit connected to the supply line for obtaining hydrogen and obtaining hydrocarbon; and selective supplying hydrogen, hydrocarbon, or a mixture of hydrocarbon and hydrogen to the at least one combustion chamber depending on the mode of operation of the gas turbine. A fuel supply system for at least one combustion chamber of a gas turbine is also provided.

### TECHNICAL FIELD

The present invention relates, in general, to the fuel supply for a combustion chamber of gas turbine and, more specifically, to the separation of a blend of hydrocarbon and hydrogen intended to supply a combustion chamber in a gas turbine.

In particular, the invention relates to a method for supplying fuel into at least one combustion chamber of gas turbine, and an associated fuel supply system, allowing the separation of a blend of hydrocarbon and hydrogen intended to feed the combustion chamber.

### BACKGROUND

In recent years, there has been growing interest and activity in the development of energy sources derived from non-fossil fuels, such as electricity generated from solar or wind energy and electricity produced from hydrogen. This development has led to the production of hydrogen from surplus renewable energy for injection into natural gas pipelines.

Indeed, the European Union Directive 2003/55/EC opened up access to the existing natural gas transmission and distribution network with the possibility of co-transporting hydrogen blended with natural gas. The resulting blend of natural gas and hydrogen reduces the carbon intensity of the hydrocarbons, when burned in gas turbine engines.

In addition, use of hydrogen in the combustion systems of gas turbine engines is advantageous because it does not produce compounds that are considered harmful to the environment, such as: S, CO₂, CO, particulate matter and unburned hydrocarbons.

Typically, the initial mixture could contain about 1% hydrogen, and it can reach up to 20%.

However, hydrogen can lead to various operational hazards when used in a gas turbine engine: for instance, explosion, flame retention, etc. In particular, during start-up of a gas turbine engine with a fuel mixture comprising a percentage of hydrogen greater than 5%, and in case the start-up stage is disturbed, a volume of hydrogen-containing gas can be found in the internal cavities of the turbine, downstream of combustion system, and up to the exhaust. The fraction of hydrogen then present in the internal cavities of the gas turbine engine can, in combination with high temperatures, generate an explosion and cause an overpressure by deflagration. Thus, it is necessary to ensure the safe start-up of a gas turbine engine by eliminating the risks incurred during combustion using a high percentage of hydrogen in the fuel mixture.

The purpose of the present disclosure is therefore to remedy these disadvantages and to propose a method for supplying the combustion chamber of a gas turbine engine with hydrocarbons bereft of hydrogen, in particular when this makes it possible to limit the risks associated with its use, from a blend of hydrocarbon and hydrogen conveyed to the gas turbine by an industrial gas network, transmission or distribution.

Hydrogen can be separated from the blend by a physical process that involves diffusing hydrogen through a membrane that can be made of polymer, metal, ceramic, or even in liquid form. However, when separation uses this technology, it must be considered that it generally has difficulty tolerating certain molecules, particularly acids, hexanes and sulphites. These molecules tend to degrade the polymeric structure of membranes. In addition, molecules with large carbon chains condense easily and clog the filters, thus reducing the efficiency of the membrane.

### BRIEF DESCRIPTION

Therefore, a method for supplying at least one gas turbine combustion chamber is proposed, including: directing a blend of hydrocarbon and hydrogen into a supply line connected to the at least one combustion chamber; separating the blend of hydrocarbon and hydrogen in a bypass circuit connected to the supply line for obtaining hydrogen and hydrocarbon separately; and selectively supplying hydrogen, hydrocarbon, or a blend of hydrocarbon and hydrogen to the at least one combustion chamber depending on the mode of operation of the gas turbine.

Advantageously, the bypass circuit may include at least one hydrocarbon tank, the method comprising: determining a quantity of hydrocarbon in the at least one hydrocarbon tank; comparing the quantity of hydrocarbon determined with a predetermined hydrocarbon threshold value; wherein the step of directing the blend of hydrocarbon and hydrogen into the supply line occurs when the determined quantity of hydrocarbon is less than the predetermined threshold value of hydrocarbon, of a blend of hydrocarbon and hydrogen in the supply line; wherein the step of separating the hydrocarbon and hydrogen blend in the bypass circuit for obtaining hydrogen and obtaining hydrocarbon occurs during the operation of the gas turbine or when the gas turbine is stopped; and storing, in the at least one hydrocarbon tank, the obtained hydrocarbon from separating the blend of hydrocarbon and hydrogen until a quantity of hydrocarbon greater than or equal to the predetermined hydrocarbon threshold value is obtained.

Preferably, the predetermined threshold value is associated with a quantity of hydrocarbon required for operating the gas turbine during at least one transient phase.

Advantageously, the transient phase can be one of the following: ignition, start-up, stop, and a change in the combustion mode of the gas turbine, or even an increase or decrease in the load in response to an electric network event to which it is connected.

Preferably, the bypass circuit comprises at least one hydrogen tank, the method comprising: storing, in the at least one hydrogen tank, the hydrogen obtained after the separating of the blend of hydrocarbon and hydrogen.

Advantageously, the method comprises feeding the hydrocarbon separated from the blend of hydrocarbon and hydrogen through the supply line of at least one combustion chamber; and operating the at least one combustion chamber of the gas turbine with the hydrocarbon (e.g., during a transient phase).

Preferably, the method includes measuring the hydrogen content in the hydrocarbon previously separated from the blend of hydrocarbon and hydrogen in the bypass circuit.

Advantageously, the method can include further separating hydrogen from the blend of hydrocarbon and hydrogen when the measured hydrogen content is above a predetermined hydrogen threshold value, e.g., in the case of membrane fouling.

Preferably, the method further comprises: storing, in the at least one hydrocarbon tank, the hydrocarbon obtained after the step of further separating the blend of hydrocarbon and hydrogen; obtaining a blend of hydrocarbon and hydrogen in which the hydrocarbon and hydrogen fractions are controlled, from the hydrocarbon stored in the at least one hydrocarbon tank and the hydrogen stored in the at least one hydrogen tank; and feeding the at least one combustion chamber with a blend of hydrocarbon and hydrogen in controlled fractions.

For example, the feeding method may include obtaining a blend of hydrocarbon with hydrogen with controlled fractions either enriched or poor in hydrogen compared to the blend of hydrocarbon and hydrogen in the industrial, transmission or distribution gas network.

The present disclosure also relates to a fuel supply system for at least one combustion chamber in a gas turbine having: a fuel supply line for supplying the at least one combustion chamber with a blend of hydrocarbon and hydrogen having: an intake section intended to be connected to an industrial, transmission or distribution gas network providing a blend of hydrocarbon and hydrogen; a separation section adjacent to the intake section and connected to an inlet of the blend of hydrocarbon and hydrogen in a bypass circuit having at least one separation device DS1 for separating the blend of hydrocarbon and hydrogen; an injection section adjacent to the separation section connected to a hydrocarbon outlet and a hydrogen outlet of the bypass circuit; a feed section adjacent to the injection section and connected to the at least one combustion chamber of the gas turbine; and a plurality of valves, each respectively positioned between the intake section and the separation section, between the separation section and the injection section, between the injection section and the feed section, between the separation section of the fuel supply line and the inlet of the blend of hydrocarbon and hydrogen in the bypass circuit, between the hydrocarbon outlet of the bypass circuit and the feed section of the fuel supply line, and between the hydrogen outlet of the bypass circuit and the injection section of the fuel supply line.

Preferably, the bypass circuit comprises a hydrocarbon tank positioned downstream of the at least one separation device, the at least one separation device configured for separating the blend of hydrocarbon and hydrogen, and the hydrocarbon tank having a capacity greater than or equal to a predetermined hydrocarbon threshold value.

Preferably, the fuel supply system includes a management calculator configured to order, when the quantity of hydrocarbon in the hydrocarbon tank is below the predetermined hydrocarbon threshold value: an intake of the blend of hydrocarbon and hydrogen into the fuel supply line; separation of the blend of hydrocarbon and hydrogen in the bypass circuit for the production of hydrocarbon; and storage, in the hydrocarbon tank, of the hydrocarbon obtained from the separation, until a quantity of the hydrocarbon greater than or equal to the predetermined hydrocarbon threshold value is obtained.

Advantageously, the fuel supply system may include at least one gas analyzer positioned downstream of the separation device for separating the blend of hydrocarbon and hydrogen and configured to measure the content of hydrogen in the hydrocarbon obtained after separation by the separation device of the blend of the hydrocarbon and hydrogen. Thus, it is possible to verify the efficiency of the separation process and to compare the hydrogen content with a predefined expected hydrogen level.

Advantageously, the bypass circuit may include an additional separation device for the blend of hydrocarbon and hydrogen positioned downstream of the separation device. The presence of an additional separation device is particularly advantageous in order to increase the efficiency of the separation process.

Preferably, the bypass circuit includes at least one hydrogen tank for the storage of hydrogen previously separated from the hydrocarbon by the separation device or by the additional separation device.

### BRIEF DESCRIPTION OF THE DRAWING

Other purposes, advantages and characteristics will be shown in the following description, which is for illustrative purposes only and is made with reference to the annexed drawing on which:

FIG. 1 is a schematic representation of a fuel supply system of a gas turbine combustion chamber according to an embodiment of the invention.

### DETAILED DESCRIPTION

In the following, the term “at least one” used in this description is equivalent to the term “one or more.”

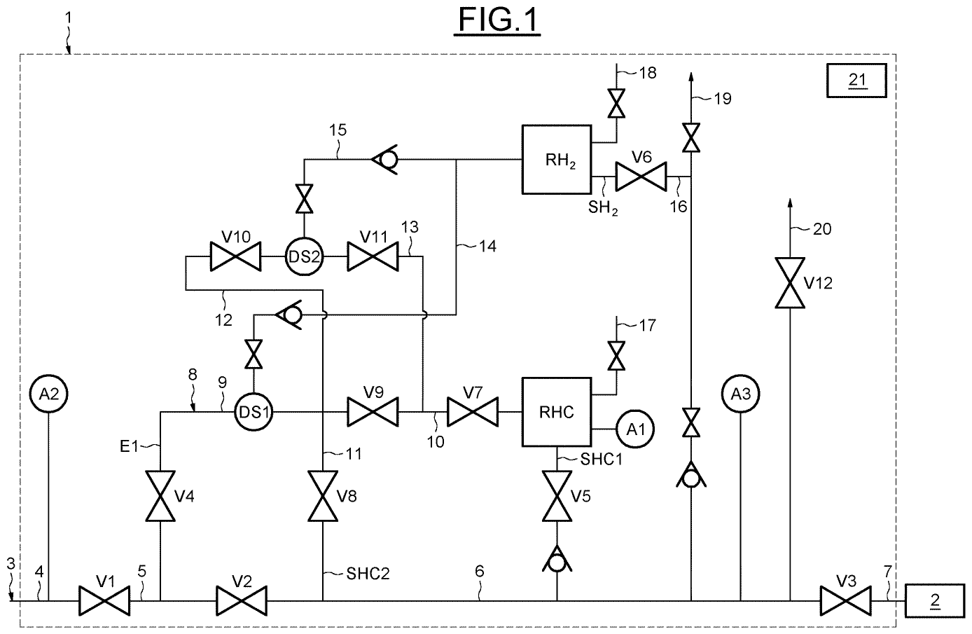

FIG. 1 shows a fuel supply system 1 designed to feed fuel to at least one combustion chamber 2 in a gas turbine. The fuel supply system 1 includes a fuel supply line 3 for the combustion chamber 2. Fuel supply line 3 of fuel supply system 1 can be expected to supply fuel to a plurality of combustion chambers 2 in the gas turbine.

Fuel supply line 3 consists of an intake section 4, a separation section 5, an injection section 6 and a feed section 7. The intake section 4 is intended to be connected to an industrial, transportation or distribution gas network providing a blend of hydrocarbon with hydrogen, external to fuel supply system 1, and allows the intake of a blend of hydrocarbon with hydrogen into fuel supply line 3. The network can be an industrial, a transmission and/or a distribution gas network carrying a blend of hydrocarbon with hydrogen. In the example depicted, the network providing the blend of hydrocarbon with hydrogen is a distribution gas network.

The mixture, which is transported and then distributed through the industrial, transmission or distribution gas network, may include a hydrocarbon or a plurality of hydrocarbons of a different nature. The amount of hydrogen in the blend of hydrocarbon with hydrogen distributed by the industrial, transmission or distribution gas network can be between 0 and 20%.

In the present invention, the terms “upstream” and “downstream” are considered in relation to the direction of flow of the fuel flow in the gas turbine, in particular between intake section 4 and combustion chamber 2 of the gas turbine.

The separation section 5 is positioned downstream of and adjacent to intake section 4. The separation section 5 is connected to an inlet El of a bypass circuit 8 for the intake of a blend of hydrocarbon with hydrogen into bypass circuit 8. The bypass circuit 8, connected to separation section 5, is positioned parallel to fuel supply line 3.

Bypass circuit 8 shall have at least one separation device DS1 for a blend of hydrocarbon with hydrogen to separate the hydrocarbon and hydrogen from the mixture into two separate streams with a given efficiency. Preferably, the separation device DS1 is a membrane of the type: polymer, metal, ceramic, or even in liquid form.

The injection section 6 is positioned downstream of separation section 5 and adjacent to it. In addition, the injection section 6 is connected to a hydrocarbon outlet SHC1 and a hydrogen outlet SH2 of bypass circuit 8.

Feed section 7 is adjacent to the injection section 6 and connected to the gas turbine combustion chamber 2. In an embodiment in which fuel supply line 3 is connected to several combustion chambers 2, feed section 7 terminates in each of them.

In addition, fuel supply system 1 includes a plurality of valves to selectively govern fluid communication between various adjacent portions of fuel supply system 1. A valve V1 is positioned between intake section 4 and separation section 5. A valve V2 is positioned between separation section 5 and injection section 6. A valveV3 is positioned between injection section 6 and feed section 7.

A first portion 9 of bypass circuit 8 extends between the blend of hydrocarbon with hydrogen inlet E1 connected to intake section 4 of fuel supply line 3 and the separation device DS1. A valve V4 is positioned on the first portion 9, between separation section 5 of fuel supply line 3 and inlet E1 of the blend of hydrocarbon with hydrogen in the bypass circuit 8, to control the passage of blend hydrocarbon-hydrogen into bypass circuit 8.

A second portion 10 of bypass circuit 8 extends from the separation device DS1 and is connected to the injection section 6 of fuel supply line 3 by the hydrocarbon outlet SHC1. A valve V5 is positioned on the second portion 10 of bypass circuit 8, between the hydrocarbon outlet SHC1 of bypass circuit 8 and the injection section 6 of fuel supply line 3. In addition, a valve V6 is positioned between the hydrogen outlet SH2 of bypass circuit 8 and the injection section 6 of fuel supply line 3.

Advantageously, a valve (not shown) can be positioned between the industrial, transmission or distribution gas network providing a blend of hydrocarbon with hydrogen and intake section 4, in order to control the intake of fuel into fuel supply line 3.

Preferably, bypass circuit 8 includes a hydrocarbon tank RHC, positioned downstream of the separation device DS1 for separating the blend of hydrocarbon with hydrogen, on the second portion 10 of bypass circuit 8. The hydrocarbon tank RHC allows the storage of hydrocarbon previously separated from hydrogen, according to a given efficiency, in the separation device DS1. The bypass circuit 8 may be expected to include multiple hydrocarbon tanks. The capacity of the hydrocarbon tank RHC is advantageously greater than or equal to a predetermined hydrocarbon threshold value.

Preferably, bypass circuit 8 of fuel supply system 1 also includes a hydrogen tank RH2, for the storage of hydrogen previously separated from the hydrocarbon, at a given efficiency, by the DS1 separation device. The bypass circuit 8 may be expected to include multiple hydrogen tanks RH2.

Preferably, bypass circuit 8 has an additional hydrocarbon outlet SHC2 to the injection section 6 of fuel supply line 3. The supplemental hydrocarbon outlet SHC2 is located on a third portion 11 of the bypass circuit 8 connecting the separation device DS1 to injection section 6 of fuel supply line 3. The supplemental hydrocarbon outlet SHC2 is positioned downstream of the separation device DS1 and upstream of the hydrocarbon tank RHC, so as to allow the intake of hydrocarbon into fuel supply line 3 directly after its separation from the blend of hydrocarbon with hydrogen.

The valves V7 and V8 can be advantageously arranged, respectively, on the second and third portions 10, 11 of bypass circuit 8, between the separation device DS1 and the hydrocarbon tank RHC and between the separation device DS1 and the injection section 6. The valves V7 and V8 are used to control the passage to the hydrocarbon injection section 6 directly after separation by the separation device DS1 via the hydrocarbon outlet SHC2 or from hydrocarbon previously stored in hydrocarbon tank RHC via the hydrocarbon outlet SHC1.

The fuel supply system 1 may include a compressor (not shown) positioned downstream of the valve V8 on the supplementary hydrocarbon outlet SHC2 in order to achieve a gas pressure similar or close to the gas pressure prior to separation.

Advantageously, fuel supply system 1 can include at least one analyzer for hydrogen content. An analyzer A1, positioned downstream of the separation device DS1, is configured to measure the possible hydrogen content in the hydrocarbon obtained after separation by the separation device DS1. In the example shown, analyzer Al is positioned to measure the level of hydrogen content present in the hydrocarbon stored in the hydrocarbon tank RHC.

In the example shown, fuel supply system 1 comprises an additional analyzer A2 positioned on intake section 4 of fuel supply line 3 and another additional analyzer A3 positioned on injection section 6 downstream of the outlets for hydrocarbon SHC1 and for hydrogen SH2 of bypass circuit 8. The additional analyzer A2 is advantageous for measuring the hydrogen content of the blend of hydrocarbon and hydrogen distributed by the industrial or transportation gas network. The additional analyzer A3 is advantageous for measuring the hydrogen content of the hydrocarbon and hydrogen blend in the injection section 6, feeding directly into combustion chamber 2 via valve V3.

Preferably, bypass circuit 8 advantageously includes an additional separation device DS2 disposed, in the example shown, downstream of the separation device DS1 and upstream of the hydrocarbon tank RHC. The additional separation device DS2 allows additional separation of the hydrogen present in the hydrocarbon, previously separated by the separation device DS1, depending on the hydrogen content measured by the analyzer downstream Al of the separation device DS1, i.e., when an improvement in separation efficiency is required.

A fourth portion 12 of bypass circuit 8 connects the separation device DS1 and the additional separation device DS2. A valve V10 is conveniently located between the separation device DS1 and the additional separation device DS2. A fifth portion 13 of bypass circuit 8 connects the additional separation device DS2 and the second portion 10 of bypass circuit 8, upstream of the hydrocarbon tank RHC, preferably between valves V7 and V9.

The hydrogen separated by the separation device DS1 is conveyed to the hydrogen tank RH₂ through a sixth portion 14 in the bypass circuit 8. The hydrogen separated by the additional separating device DS2 is conveyed to the hydrogen tank RH2 through a seventh portion 15 of bypass circuit 8. An eighth portion 16 connects the hydrogen tank RH2 to the injection section 6 of the fuel feed line 3 for the injection of hydrogen previously separated from the hydrocarbon into the combustion chamber 2 or a blend of hydrocarbon with hydrogen, the rates of which can be controlled, depending on the operating supply mode required by the gas turbine.

Advantageously, non-return valves are positioned on the sixth, seventh, eighth portions 14, 15 and 16, as well as on the second portion 10, downstream of the hydrocarbon tank RHC.

Preferably, a vent 17, 18 is placed respectively on the hydrocarbon RHC and hydrogen RH2 tanks. In addition, a vent 19 can also be placed on the eighth portion 16 of bypass circuit 8, downstream of valve V6. Preferably, a vent 20 is also arranged on injection section 6 of fuel feed line 3, downstream of bypass circuit 8. The opening and closing of vent 20 is controlled by a valve V12 in order to purge the injection section 6. The opening and closing of each vent 17, 18, 19 and 20 is advantageously controlled by dedicated valves (not separately numbered).

Preferably, fuel supply system 1 additionally includes a controller or management calculator 21 configured to control the opening and closing of all valves in fuel supply system 1. Preferably, the management calculator 21 is configured to order, when the amount of hydrocarbon in the hydrocarbon tank RHC is below a hydrocarbon threshold value predetermined by: the intake of blend of hydrocarbon and hydrogen into fuel supply line 3, separation of blend of hydrocarbon with hydrogen by bypass circuit 8 for the production of hydrocarbon, and storage of the hydrocarbon obtained in the hydrocarbon tank RHC until a quantity of hydrocarbon greater than or equal to the predetermined hydrocarbon threshold value is obtained.

The invention also relates to a method for supplying fuel to the gas turbine combustor (e.g., combustion chamber 2). A plurality of combustion chambers 2 can be supplied with fuel. The feeding method includes a first step of intake of a blend of hydrocarbon with hydrogen, from the industrial, transmission or distribution gas network, into fuel supply line 3.

In a second step, a separation of blend of hydrocarbon with hydrogen is implemented in bypass circuit 8, which is connected to fuel supply line 3, to obtain in one side hydrogen and the other side hydrocarbon.

In a third step, combustion chamber 2 is selectively fed either with hydrogen or with hydrocarbon, previously separated in the second stage, or even with a mixture of hydrocarbon and hydrogen not separated by bypass circuit 8. Selective supply of hydrocarbon, hydrogen or controlled blend of hydrocarbon and hydrogen to the combustion chamber can be easily achieved, depending on the mode of operation or the need for the transient modes of the gas turbine.

Fuel supply system 1 is a simple system that allows fuel to be supplied to at least one combustion chamber 2 via a single fuel supply line 3, from a blend of hydrocarbon and hydrogen distributed through an industrial, transmission or general gas distribution network, regardless of the mode of operation of the gas turbine. In particular, it is thus possible to supply the combustion chamber 2 with hydrocarbon separated, at least partially, from hydrogen, preferably until a predetermined threshold value of hydrogen content in the separated hydrocarbon is reached, so as to allow the operation of the gas turbine without risks associated with the presence of hydrogen, in particular during transient phases subject to flame loss such as, e.g. starting or stopping the gas turbine.

In this respect, the method preferably comprises the supply of hydrocarbon from combustion chamber 2 to the supply line 3 of the previously separated mixture of hydrocarbon and hydrogen in bypass circuit 8, for the operation of the gas turbine during a transient phase. The content of hydrogen present in the hydrocarbon separated from the blend of hydrocarbon with hydrogen may be below a predetermined threshold value below which the risks associated with hydrogen present in the internal cavities of the gas turbine, such as explosion, are removed. According to one example, the predetermined threshold value of the amount of hydrogen in the hydrocarbon separated by the separation device DS1 can be 5%.

Advantageously, the supplying method includes the determination of a quantity of hydrocarbon in the hydrocarbon tank RHC, preferably prior to a transient phase. The comparison of the determined quantity of hydrocarbon with a predetermined hydrocarbon threshold value is then implemented. When the specified quantity of hydrocarbon is less than the predetermined hydrocarbon threshold value, then a blend of hydrocarbon with hydrogen shall be admitted to fuel supply line 3. The blend of hydrocarbon with hydrogen admitted to fuel supply line 3 is then separated in bypass circuit 8 to obtain hydrocarbon. The hydrocarbon obtained is then stored in the hydrocarbon tank RHC until a quantity of hydrocarbon greater than or equal to the predetermined hydrocarbon threshold value is obtained.

In one embodiment, the separation of the blend of hydrocarbon with hydrogen and the storage of the resulting hydrocarbon are carried out when the gas turbine is stopped, and preferably before a transient phase. The separation and storage of hydrocarbon prior to the start-up of the gas turbine is particularly advantageous in order to ensure that the combustion chamber 2 is supplied with sufficient quantities of hydrocarbon without at least partial hydrogen.

In another embodiment, the separation of the blend of hydrocarbon with hydrogen and the storage of the obtained hydrocarbon are carried out during the operation of the gas turbine. Separation and storage during gas turbine operation are particularly advantageous for adjusting or refill the hydrocarbon tank RHC when it does not contain, or no longer contains a sufficient quantity of separated hydrocarbon.

Preferably, the predetermined threshold value is associated with a quantity of hydrocarbon required for the operation of the gas turbine during at least one transient phase. The separation of the blend of hydrocarbon with hydrogen and the storage of the obtained hydrocarbon thus allow the gas turbine to have a sufficient quantity of separated hydrocarbon for operation during a transient phase.

Advantageously, the transient phase can be one of the following: ignition, starting, stopping, or a change in the combustion mode of the gas turbine.

Preferably, the supplying method includes the measurement of the hydrogen content in the hydrocarbon previously separated from the blend of hydrocarbon with hydrogen in the bypass circuit 8. In the example shown, the measurement is made by the gas analyzer Al in the hydrocarbon tank RHC. In one embodiment, the predetermined threshold value of the hydrogen content in the hydrocarbon after simple separation by the DS1 separation device may be 5%.

In addition, the supplying method may include an additional separation step when the measured hydrogen content is above a predetermined hydrogen threshold value. The implementation of the double separation can be controlled manually or automatically by the management calculator 21. According to an example, when the hydrogen content in the hydrocarbon after a single separation by the separation device DS1 is greater than or equal to 5%, then a double separation can be implemented with the separation devices DS1 and the additional separation device DS2 together.

Preferably, the hydrogen content is measured by the gas analyzer Al at the beginning of the separation step by the separation device DS1 and the storage step in the hydrocarbon tank RHC so as to rapidly rectify the hydrogen level in the hydrocarbon to be stored in the hydrocarbon tank RHC. According to another embodiment, the second separation by the separation device DS2 can be carried out after complete storage of the hydrocarbon separated by the separation device DS1. In the example shown, the hydrocarbon tank RHC is filled when the gas turbine is stopped, before start up.

In the case of a simple separation, valves V1, V4, V9 and V7 are opened, preferably controlled by the management calculator 21. The blend of hydrocarbon with hydrogen is admitted into intake section 4 of fuel supply line 3 and then into separation section 5 and proceeds to first portion 9 of bypass circuit 8 to be separated by the separation device DS1. After separation, the separated hydrocarbon is conveyed to the hydrocarbon tank RHC through the second portion 10 for filling the hydrocarbon tank RHC to the predetermined threshold value necessary for the operation of the gas turbine during one or more transient phases.

In the case of a double separation, valve V9 is closed, and valves V1, V4, V10, V7 and V11 are opened, preferably commanded by the controller 21. The blend of hydrocarbon with hydrogen is admitted into intake section 4 of fuel supply line 3 and then into separation section 5 and proceeds to the first portion 9 of bypass circuit 8 to be separated by the separation device DS1, and then successively by the additional separation device DS2, the hydrocarbon separated by the separation device DS1 reaching the fourth portion 12 in the bypass circuit 8. After double separation, the separated hydrocarbon is conveyed to the hydrocarbon tank RHC through the fifth portion 13 and the second portion 10 for the filling of the hydrocarbon tank RHC to the predetermined threshold value.

The hydrogen separated by the separation device DS1 is conveyed to the hydrogen tank RH2 through the sixth portion 14 of bypass circuit 8. The hydrogen separated by the additional separation device DS2 is conveyed to the hydrogen tank RH2 through the seventh portion 15 of bypass circuit 8.

In one embodiment, fuel supply system 1 may include an auxiliary boiler or other steam device (not shown) connected to the hydrogen tank RH2. In this way, the auxiliary boiler can use hydrogen H2 stored in the hydrogen tank RH2 for its operation. The auxiliary boiler or other steam device can be positioned downstream of the gas turbine.

In one embodiment, fuel supply system 1 may include a methane pyrolysis device to produce hydrogen and carbon from a methane source. The pyrolysis device may be provided to be connected either to the fuel supply line 3, in intake section 4, or to the hydrocarbon tank RHC.

In this embodiment, the hydrocarbon stored in the hydrocarbon tank RHC will therefore be methane. When the blend admitted in intake section 4 of fuel supply line 3 consists only of methane hydrocarbon, the connection of the pyrolysis device to fuel supply line 3 is particularly advantageous, in order to be able to separate, prior to pyrolysis, the hydrogen from the mixture via bypass circuit 8.

In addition, the blend of hydrocarbon with hydrogen fed into the fuel supply system may contain mercaptan, a molecule designed to odorize the fuel. The mercaptan may be filtered out and retained by the DS1 separation device. It may therefore be necessary to add mercaptan back to the hydrocarbon after separation of the hydrogen. In this respect, it may be provided that the supplying method will include a step of adding mercaptan to the previously separated hydrocarbon, downstream of the separation device DS1 or the additional separation device DS2. Advantageously, the addition of mercaptan can be carried out in the hydrocarbon tank RHC.

In addition, it may be possible that the fuel supply system 1 will include a device for separating heavy fractions of the hydrocarbon previously separated from the hydrogen. For example, hydrocarbon may include a blend of methane, ethane and propane. Fuel supply system 1 may include a separation device to separate heavy fractions such as ethane and propane from methane. Advantageously, the device for separating heavy fractions of the previously separated hydrocarbon from hydrogen can be positioned downstream of separation device the DS1 or downstream of the additional separation device DS2 and upstream of the hydrocarbon tank RHC.

Preferably, during a first stage of pre-ignition of the gas turbine, a venting of the injection section 6 is carried out using vent 20 located downstream of bypass circuit 8. Valves V1, V2, V3, V4, V7, V8, V10 are closed, and valve V12 is open.

Preferably, during a second stage of ignition of the gas turbine, the vent valve V12 is closed, valves V3 and V5 are opened, the hydrocarbon stored in the tank RHC is admitted into injection section 6 of the fuel supply line 3 and feeds combustion chamber 2 during an attempt to ignite a mixture of air and hydrocarbon previously separated from the hydrogen and as shown in the example coming, from the hydrocarbon tank RHC. The supply is carried out until the fuel mixture is actually ignited in combustion chamber 2. The attempt at ignition can be carried out via a spark plug. Ignition can be confirmed by a flame detector.

When ignition transient phase of gas turbine is completed, the combustion chamber 2 is therefore ignited. A feed transfer of the injection section 6 is then carried out. The fuel gas supply through bypass circuit 8 via valve V5 is transferred to a supply through the hydrocarbon mixture and of hydrogen from the industrial, transmission or distribution gas network, without prior separation of the hydrogen. The valve V5 will gradually close while the valves V1 and V2 will gradually open in order to supply the injection section 6. This is followed by an acceleration phase of the gas turbine.

In one embodiment, it is possible to feed combustion chamber 2 from hydrogen previously stored in the hydrogen tank RH2 during single or double separation. Valves V3 and V6 and the valve downstream of valve V6 in the direction of injection section 6 are open for intake of hydrogen to injection section 6 of fuel supply line 3 routed through the eighth portion 16 and supply the combustion chamber 2.

The hydrogen content of the fuel gas composition admitted to combustion chamber 2 can be variable, preferably from 0 to 20% or from 5 to 20% hydrogen, with a theoretical hydrogen variation estimated for example between 0 and 30% per minute. In this case, the rate of hydrocarbon, e.g. methane, and hydrogen delivered by the injection section 6 of the fuel supply system 1 can be adjusted in order to ensure a constant composition for the transient phases, for example to ensure a response to the grid network with a 10% increase in its nominal load for example in 30 seconds.

Thus, in order to maintain controlled fractions of hydrocarbon and hydrogen, e.g. methane, and constant hydrogen during a transient operation, fuel supply system 1 may provide: adjusting the hydrogen rate upwards by injecting more hydrogen from the hydrogen tank RH2, or adjustment to lower the hydrogen rate, either by adding hydrocarbon, such as methane, from the hydrocarbon tank RHC, or by injecting hydrocarbon, such as methane, directly downstream of bypass circuit 8, without passing through the hydrocarbon tank RHC.

1-16 (canceled)

17. A method for supplying fuel to at least one combustion chamber of a gas turbine, the method comprising:
directing a blend of hydrocarbon and hydrogen into a supply line connected to the at least one combustion chamber;
separating the blend of hydrocarbon and hydrogen in a bypass circuit connected to the supply line for obtaining hydrogen and obtaining hydrocarbon; and
selectively supplying hydrogen, hydrocarbon, or a blend of hydrocarbon and hydrogen to the at least one combustion chamber depending on the mode of operation of the gas turbine.

18. The method of claim 17, wherein the bypass circuit comprises at least one hydrocarbon tank, the method comprising:
determining a quantity of hydrocarbon in the at least one hydrocarbon tank;
comparing the determined quantity of hydrocarbon with a predetermined hydrocarbon threshold value;
wherein the step of directing the blend of hydrocarbon and hydrogen into the supply line occurs when the determined quantity of hydrocarbon is less than the predetermined hydrocarbon threshold value;
wherein the step of separating the blend of hydrocarbon and hydrogen in the bypass circuit for obtaining hydrogen and obtaining hydrocarbon occurs during the operation of the gas turbine or when the gas turbine is stopped; and
storing, in the at least one hydrocarbon tank, the hydrocarbon obtained from separating the blend of hydrocarbon and hydrogen until a quantity of hydrocarbon greater than or equal to the predetermined hydrocarbon threshold value is obtained.

19. The method of claim 18, wherein the predetermined threshold value is associated with a quantity of hydrocarbon required for operating the gas turbine during at least one transient phase.

20. The method of claim 19, wherein the transient phase is one of the following:
ignition, start-up, stop, and a change in the mode of combustion of the gas turbine.

21. The method according to claim 18, wherein the bypass circuit comprises at least one hydrogen tank, the method comprising: storing, in the at least one hydrogen tank, the hydrogen obtained after the separating of the blend of hydrocarbon and hydrogen.

22. The method according to claim 18, the method comprising:
feeding the hydrocarbon separated from the blend of hydrocarbon and hydrogen through the supply line to at least one combustion chamber; and
operating the at least one combustor chamber of the gas turbine with the hydrocarbon.

23. The method according to claim 18, comprising measuring the hydrogen content in the hydrocarbon previously separated from the blend of hydrocarbon with hydrogen in the bypass circuit.

24. The method of claim 23, comprising further separating hydrogen from the blend of hydrocarbon and hydrogen when the measured hydrogen content is greater than a predetermined hydrogen threshold value.

25. The method according to claim 24, wherein the bypass circuit comprises at least one hydrogen tank, the method comprising storing, the hydrogen tank, the hydrogen obtained after the step of further separating the blend of hydrocarbon and hydrogen.

26. The method of claim 24, comprising:
storing, in the at least one hydrocarbon tank, the hydrocarbon obtained after the step of further separating the blend of hydrocarbon and hydrogen;
obtaining a blend of hydrocarbon and hydrogen in which the hydrocarbon and hydrogen fractions are controlled, from the hydrocarbon stored in the at least one hydrocarbon tank and the hydrogen stored in the at least one hydrogen tank; and
feeding the at least one combustion chamber with a blend of hydrocarbon and hydrogen in controlled fractions.

27. A fuel supply system for at least one combustion chamber of a gas turbine, the fuel supply system comprising:
a fuel supply line for supplying the at least one combustion chamber with a blend of hydrocarbon and hydrogen comprising:
an intake section intended to be connected to an industrial, transmission, or distribution gas network providing a blend of hydrocarbon and hydrogen;
a separation section adjacent to the intake section and connected to an inlet of the blend of hydrocarbon and hydrogen in a bypass circuit having at least one separation device for separating the blend of hydrocarbon and hydrogen;
an injection section adjacent to the separation section connected to an outlet of hydrocarbon and to an outlet of hydrogen in the bypass circuit;
a feed section adjacent to the injection section and connected to the at least one combustion chamber of the gas turbine; and
a plurality of valves each positioned respectively between the intake section and the separation section, between the separation section and the injection section, between the injection section and the feed section, between the separation section of the fuel supply line and the inlet of blend of hydrocarbon with hydrogen in the bypass circuit, between the hydrocarbon outlet of the bypass circuit and the injection section of the fuel supply line, and between the hydrogen outlet of the bypass circuit and the injection section of the fuel supply line.

28. The system according to claim 27, wherein the bypass circuit comprises a hydrocarbon tank positioned downstream of the at least one separation device, the separation device configured for separating the blend of hydrocarbon and hydrogen, and the hydrocarbon tank having a capacity greater than or equal to a predetermined hydrocarbon threshold value.

29. The system of claim 28, comprising a management calculator configured to order, when the quantity of hydrocarbon in the hydrocarbon tank is less than the predetermined hydrocarbon threshold value:
an intake of the blend of hydrocarbon and hydrogen into the fuel supply line;
separation of the blend of hydrocarbon and hydrogen in the bypass circuit for the production of hydrocarbon; and
storage, in the hydrocarbon tank, of the hydrocarbon obtained from the separation, until a quantity of the hydrocarbon greater than or equal to the predetermined hydrocarbon threshold value is obtained.

30. The system according to claim 28, comprising at least one gas analyzer positioned downstream of the separation device for separating the blend of hydrocarbon and hydrogen and configured to measure the content of hydrogen in the hydrocarbon obtained after separation by the separation device of the blend of hydrocarbon and hydrogen.

31. The system according to claim 28, wherein the bypass circuit comprises an additional separation device for the blend of hydrocarbon and hydrogen positioned downstream of the separation device.

32. The system according to claim 31, wherein the bypass circuit comprises at least one hydrogen tank, for the storage of hydrogen previously separated from the hydrocarbon by the separation device or by the additional separation device.
